(19) United States
(12) Patent Application Publication
(10) Pub. No.: US 2022/0397489 A1
(43) Pub. Date: Dec. 15, 2022

(54) BLADE HOLDER, BLADE MOVING SYSTEM AND MICROTOME

(71) Applicant: Leica Biosystems Nussloch GmbH, Nussloch (DE)

(72) Inventors: Jue CHEN, Pudong, Shanghai (CN); Song JIN, Pudong, Shanghai (CN)

(21) Appl. No.: 17/773,382

(22) PCT Filed: Oct. 30, 2019
(86) PCT No.: PCT/CN2019/114296

§ 371 Date: Apr. 29, 2022

(51) Int. Cl. G01N 1/06

(52) U.S. Cl. CPC G01N 1/06; G01N 2001/061

(57) ABSTRACT

The present disclosure relates to a blade holder (100), a blade moving system (1000) and a microtome (2000). The blade holder (100) includes a base (110) defining a blade groove (112) and a slide groove (114), the blade groove (112) being configured to accommodating a blade (900); a slide rail (120) slidably accommodated in the slide groove (114); and an engagement assembly (130) mounted to the slide rail (120) and configured to engage the blade (900) such that the blade (900) is slidable along the blade groove (112) with sliding of the slide rail (120) in the slide groove (114). By using the blade holder (100) according to embodiments of the present disclosure, the blade (900) can be moved to the left or right along the blade groove (112) by sliding the slide rail (120) in the slide groove (114), thereby facilitating fully use of the blade (900).

### FIELD

The present disclosure relates to a technical field of microtomes, and more particularly to a blade holder, a blade moving system and a microtome.

### BACKGROUND

In the related art, a blade holder is used in a microtome. The blade-holder is a mechanical component used to hold a blade. In order to fully use the blade, a user needs to slide the blade holder among three positions during use, because the blade is generally three times as long as a width of a specimen block. It is time consuming to move the blade holder to the left and to the right.

Furthermore, when replacing the blade, the user needs to release, remove, load and clamp a new blade manually, which has low efficiency and is dangerous.

### SUMMARY

Embodiments of the present disclosure seek to solve at least one of the problems existing in the related art to at least some extent.

According to a first aspect of the present disclosure, a blade holder is provided.

According to a second aspect of the present disclosure, a blade moving system is provided.

According to a third aspect of the present disclosure, a microtome is provided.

The blade holder according to embodiments of the first aspect of the present disclosure includes a base defining a blade groove and a slide groove, the blade groove being configured to accommodating a blade; a slide rail slidably accommodated in the slide groove; and an engagement assembly mounted to the slide rail and configured to engage the blade such that the blade is slidable along the blade groove with sliding of the slide rail in the slide groove.

According to at least one embodiments of the present disclosure, the engagement assembly includes a rod and a biasing part, the rod has a first end pivotally mounted to the slide rail and a second end provided with a protrusion configured to engage in a recess defined in the blade, and the biasing part is configured to bias the second end of the rod towards the blade.

According to at least one embodiments of the present disclosure, the engagement assembly further includes a limiting part configured to prevent the protrusion at the second end of the rod from moving beyond a wall face of the blade groove facing the protrusion at the second end of the rod.

According to at least one embodiments of the present disclosure, the blade holder further includes a pressure plate movably mounted to the base and configured to operatively press the blade on the base.

According to at least one embodiments of the present disclosure, the blade holder further includes a first motor secured to the base and connected to the slide rail so as to drive the slide rail to slide in the slide groove; and a second motor secured to the base and connected to the pressure plate so as to drive the pressure plate to press the blade on the base.

According to at least one embodiments of the present disclosure, the first motor is provided with a pinion at an output end thereof, the slide rail is provided with a rack, and the pinion is engaged with the rack to achieve power transmission from the first motor to the slide rail.

According to at least one embodiments of the present disclosure, the slide rail is provided with a rib at a side of the slide rail, and a side wall of the slide groove defines a slot matching the rib of the slide rail.

According to at least one embodiments of the present disclosure, the rack is provided at a lower portion of the slide rail and spaced apart from a bottom wall of the slide groove.

According to at least one embodiments of the present disclosure, the blade holder further includes a controller electrically connected to the first motor and the second motor, and the controller controls the first motor to drive the slide rail to slide in the slide groove and controls the second motor to drive the pressure plate to press the blade on the base.

According to at least one embodiments of the present disclosure, the blade holder further includes an encoder mounted to the first motor, electrically connected to the controller and detecting a position of the slide rail relative to the base.

According to at least one embodiments of the present disclosure, the blade holder further includes a control key electrically to the controller and configured to generate an operation signal in response to an operation of a user, and an indicator electrically connected to the controller and configured to show a status of the blade holder to the user.

The blade moving system according to embodiments of the second aspect of the present disclosure includes a blade holder according to any one of the above embodiments; and a first container detachably mounted to a first side of the blade holder along an extending direction of the slide groove and defining an accommodating groove configured to accommodate a blade; in which the accommodating groove of the first container is aligned with the slide groove of the base.

According to at least one embodiments of the present disclosure, the blade moving system further includes a second container detachably mounted to a second side of the blade holder opposite the first side along the extending direction of the slide groove; the second container defines an upper opening and is configured to receive the blade through the upper opening.

The microtome according to embodiments of the third aspect of the present disclosure includes a blade moving system according to any one of above embodiments; and a specimen holder disposed near the blade holder and movable vertically relative to the blade holder such that a specimen held by the specimen holder is able to pass through the blade holder and be cut by the blade holder.

The above summary of the present disclosure is not intended to describe each disclosed embodiment or every implementation of the present disclosure. The Figures and the detailed description which follow more particularly exemplify illustrative embodiments.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a perspective view of a blade moving system according to an embodiment of the present disclosure;

FIG. 2 is a section view of a blade holder according to an embodiment of the present disclosure;

FIG. 3 is a side view of a slide rail and an engagement assembly according to an embodiment of the present disclosure;

FIG. 4 is a schematic view of a protrusion of an engagement assembly according to an embodiment of the present disclosure;

FIG. 5 is a side view of a slide rail and an engagement assembly according to another embodiment of the present disclosure;

FIG. 6 is a schematic view of a blade according to an embodiment of the present disclosure;

FIG. 7 is a schematic view of a clamping drive mechanism according to an embodiment of the present disclosure; and

FIG. 8 is a block diagram of a control system according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, the term “a plurality of” means two or more than two, unless specified otherwise.

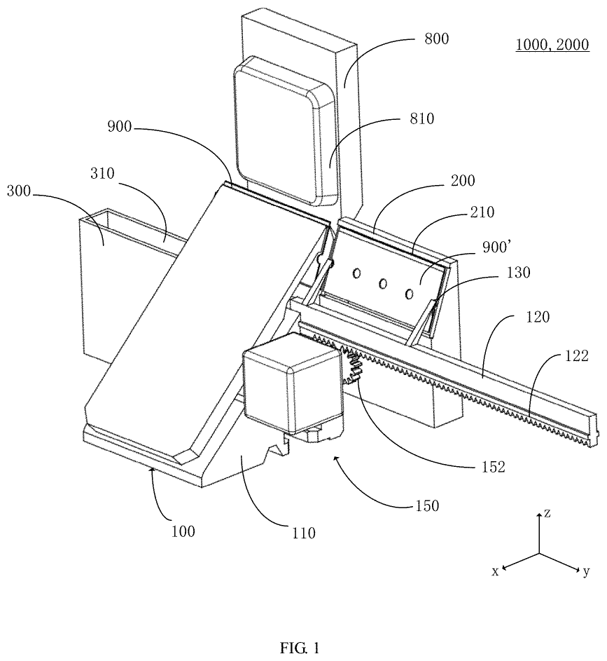

A blade holder 100 according to embodiments of the present disclosure will be described in detail below with reference to FIGS. 1 to 8. The orthogonal XYZ-axis is illustrated in order to facilitate the description and determine the directions. In which, the positive direction of the X-axis is the front direction and the negative direction of the X-axis is the rear direction; the positive direction of the Y-axis is the right direction and the negative direction of the Y-axis is the left direction; the positive direction of the Z-axis is the up direction and the negative direction of the Z-axis down direction.

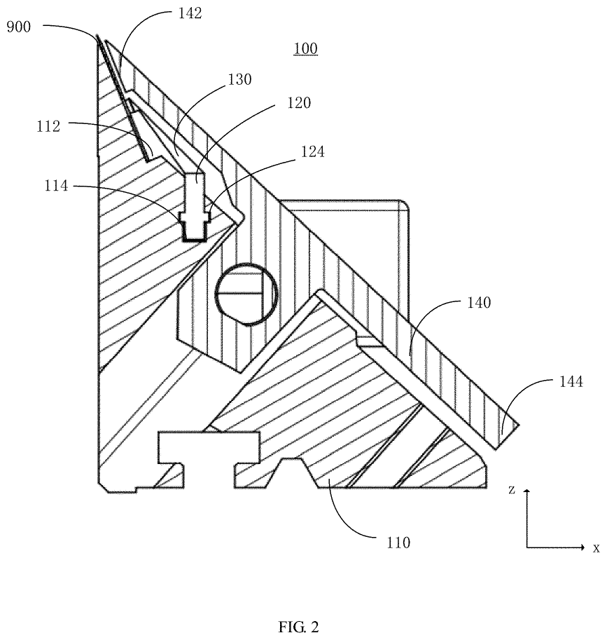

As illustrated in FIGS. 1 and 2, the blade holder 100 according to embodiments of the present disclosure includes a base 110, a slide rail 120 and an engagement assembly 130. The base 110 defines a blade groove 112 and a slide groove 114. The blade groove 112 is configured to accommodating a blade 900, and the slide rail 120 is slidably accommodated in the slide groove 114. The engagement assembly 130 is mounted to the slide rail 120 and configured to engage the blade 900 such that the blade 900 is slidable along the blade groove 112 with sliding of the slide rail 120 in the slide groove 114.

For the blade holder 100 according to embodiments of the present disclosure, the slide rail 120 is slidable in the slide groove 114 of the blade holder 100, and the slide rail 120 engages with the blade 900 through the engagement assembly 130, such that the blade 900 can be moved to the left or right along the blade groove 112 by sliding the slide rail 120 in the slide groove 114, thereby facilitating fully use of the blade 900. Furthermore, the operation is simple, time-saving and less dangerous.

In some embodiments, as illustrated in FIGS. 2, 3 and 5, the engagement assembly 130 includes a rod 132 and a biasing part. The rod 132 has a first end pivotally mounted to the slide rail 120 and a second end provided with a protrusion 134 configured to engage in a recess 910 defined in the blade 900, and the biasing part is configured to bias the second end of the rod 132 towards the blade 900, such that the protrusion 134 of the second end of the rod 132 can tightly engage in the recess 910 defined in the blade 900, and the blade 900 can be clamped between the rod 132 and the blade groove 112 and stably slid along the blade groove 112.

In an example, the biasing part may be a spring, such as a tension spring, a torsion spring, etc. It should be noted that, the specific structure of the biasing part is not limited by the present disclosure, as long as the structure of biasing part can bias the second end of the rod 132 towards the blade 900.

Furthermore, it could be understood that, the blade 900 can be tightly clamped between the rod 132 and the blade groove 112, and when the blade 900 is completely slid out of the blade groove 112, the blade 900 can disengage with the rod 132 and fall down under action of its gravity. That is, the blade 900 can be unloaded by sliding the slide rail 120 in the slide groove 114. The operation is simple, time-saving and less dangerous.

In some embodiments, as illustrated in FIG. 1, a plurality of rods 132 are provided and spaced apart from one another along an extending direction of the slide rail 120 (referring to y direction as illustrated in FIG. 1). Thus, the blade 900 can be more firmly clamped between the rod 132 and the blade groove 112 and more stably slid along the blade groove 112. For example, two rods 132 are provided and spaced apart from each other along the extending direction of the slide rail 120.

It could be understood that, a plurality of bias parts can be provided corresponding to the plurality of rods 132, and a plurality of recesses 910 can be defined in the blade 900. For example, two bias parts are provided corresponding to the two rods 132, and two recesses 910 are defined in the blade 900. Thus, the movement of the blade 900 along the blade groove 112 can be more stable.

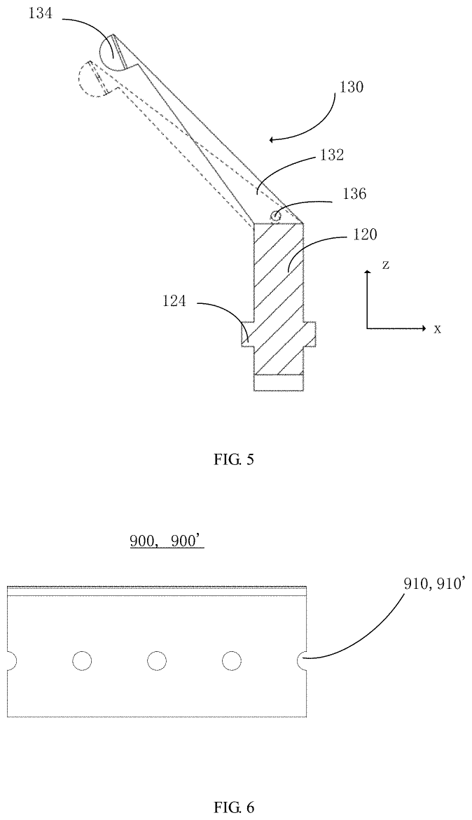

In some examples, as illustrated in FIGS. 1 and 6, the two recesses 910 are defined at two end of the blade 900 in the extending direction of the slide rail 120. Thus, the protrusion 134 of the second end of the rod 132 can easily engage in the recess 910 of the blade 900. As illustrated in FIG. 6, each recess 910 may be a half hole, and the half hole is open towards a corresponding end face of the blade 900 in a length direction of the blade 900. Thus, the protrusion 134 of the second end of the rod 132 can more easily engage in the recess 910 of the blade 900.

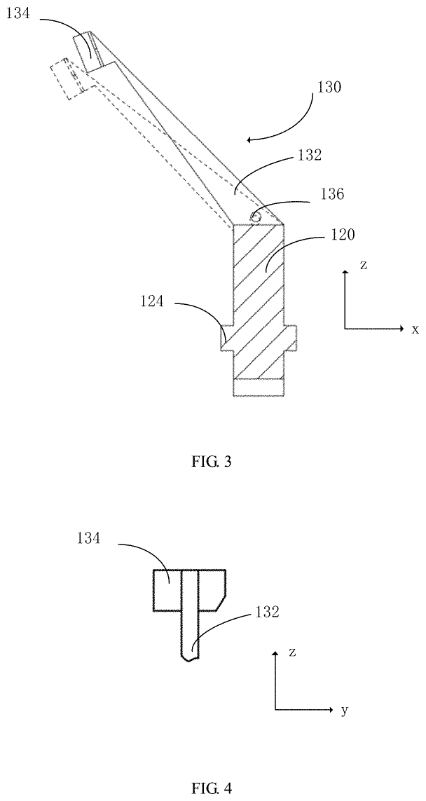

In some embodiments, as illustrated in FIGS. 3 and 5, the engagement assembly 130 further includes a limiting part 136 configured to limit the position of the protrusion 134 along a bias direction of the bias part, so as to prevent the protrusion 134 at the second end of the rod 132 from moving beyond a wall face of the blade groove 112 facing the protrusion 134 at the second end of the rod 132.

It could be understood that, after the blade 900 is slid out of the blade groove 112 and unloaded, and the rod 132 is also slid out of the blade groove 112. By providing the limiting part 136, the protrusion 134 at the second end of the rod 132 will not interfere with the wall face of the blade groove 112 facing the protrusion 134 when the rod 132 is slid back into the blade groove 112, and thus manual operation on the rod 132 can be avoided.

For example, as illustrated in FIGS. 3 and 5, the limiting part 136 may be a post extending in the length direction of the slide rail 120. The post can abut against an upper face of the slide rail 120 to limit the position of the rod 132, such that the protrusion 134 at the second end of the rod 132 will not interfere with the wall face of the blade groove 112 facing the protrusion 134 when the rod 132 is slid back into the blade groove 112, and thus manual operation on the rod 132 can be avoided. It should be noted that, the limiting part 136 may also be other structures, which is not specifically limited by the present disclosure.

In some embodiments, as illustrated in FIG. 2, the blade holder 100 according embodiments of the present disclosure further includes a pressure plate 140 movably mounted to the base 110 and configured to operatively press the blade 900 on the base 110.

Thus, when the blade 900 is slid to a suitable position in the blade groove 112, the pressure plate 140 is operated to press the blade 900 on the base 110, and the blade 900 can be firmly clamped between the pressure plate 140 and the base 110 so as to cut and trim a specimen; and when the blade 900 needs to be slid to another position along the blade groove 112 or removed, the pressure plate 140 is operated to release the blade 900, and the blade 900 can be slid by sliding the slide rail 120.

In some embodiments, as illustrated in FIGS. 1, 7 and 8, the blade holder 100 according to embodiments of the present disclosure further includes a first motor 150 secured to the base 110 and connected to the slide rail 120 so as to drive the slide rail 120 to slide in the slide groove 114; and a second motor 160 secured to the base 110 and connected to the pressure plate 140 so as to drive the pressure plate 140 to operatively press the blade 900 on the base 110. Thus, the sliding and clamping of the blade 900 can be motorized, thereby greatly reducing operational stress, increasing operational efficiency and reducing risk of cutting injury for a user.

In some embodiments, as illustrated in FIG. 1, the first motor 150 is provided with a pinion 152 at an output end thereof, the slide rail 120 is provided with a rack 122, and the pinion 152 is engaged with the rack 122 to achieve power transmission from the first motor 150 to the slide rail 120. Thus, the first motor 150 can drive the slide rail 120 to slide along the slide groove 114. Moreover, the pinion and rack mechanism is simple and cost-efficient.

In some embodiments, as illustrated in FIGS. 2, 3 and 5, the slide rail 120 is provided with a rib 124 at a side of the slide rail 120, and a side wall of the slide groove 114 defines a slot matching the rib 124 of the slide rail 120. Thus, the slide rail 120 can be supported in the slide groove 114 firmly, thereby facilitating the sliding of the slide rail 120 along the slide groove 114. In some examples, two ribs 124 are provided at two sides of the slide rail 120 respectively, and two side walls of the slide groove 114 define two slots matching the two ribs 124 of the slide rail 120 respectively. Thus, the slide rail 120 can be supported in the slide groove 114 more firmly, thereby further facilitating the sliding of the slide rail 120 along the slide groove 114.

In some embodiments, as illustrated in FIGS. 1 and 2, the rack 122 is provided at a lower portion of the slide rail 120 and spaced apart from a bottom wall of the slide groove 114. Thus, the gear of the rack 122 can be prevented from interfering with the bottom wall of the slide groove 114, thereby facilitating the sliding of the slide rail 120 along the slide groove 114, and prolonging the service life of the slide rail 120.

In some embodiments, as illustrated in FIG. 2, the pressure plate 140 is pivotally connected to the base 110. The pressure plate 140 has a first end 142 configured to press the blade 900, and a second end 144 opposite the first end 142. The pressure plate 140 has a pivot point provided between the first end 142 and the second end 144 of the pressure plate 140, and in some example, the pivot point is arranged closer to the first end 142 of the pressure plate 140 than the second end 144 of the pressure plate 140.

It could be understood that, the pressure plate 140 can act like a seesaw. When a force is applied to an underside of the second end 144 of the pressure plate 140, the first end 142 of the pressure plate 140 may press on the blade 900 received in the blade groove 112; and when the force is withdrawn from the underside of the second end 144 of the pressure plate 140, the second end 144 of the pressure plate 140 goes down under the action of the gravity and the first end 142 of the pressure plate 140 goes up, such that the pressure plate 140 release the blade 900 received in the blade groove 112.

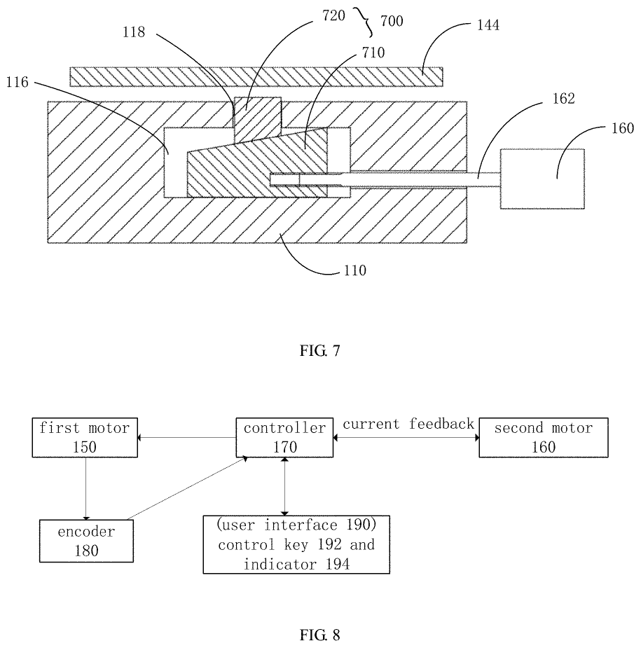

In some embodiments, as illustrated in FIG. 7, the blade holder 100 further includes a clamping drive mechanism 700, and the second motor 160 is connected to the pressure plate 140 through the clamping drive mechanism 700. The clamping drive mechanism 700 includes a first wedge member 710 and a second wedge member 720 engaging with the first wedge member 710, the first wedge member 710 is connected to an output shaft 162 of the second motor 160 and configured to be movable along an axis direction of the output shaft 162 of the second motor 160 by the second motor 160, and the second wedge member 720 is configured to move towards or away from the underside of the second end 144 of the pressure plate 140 with movement of the first wedge member 710 in the axis direction of the output shaft 162 of the second motor 160.

It could be understood that, the second motor 160 can rotate to drive the second wedge member 720 through the first wedge member 710 to move towards and abut against the underside of the second end 144 of the pressure plate 140, such that the first end 142 of the pressure plate 140 can press on the blade 900 received in the blade groove 112; and the second motor 160 can rotate inversely to cause the second wedge member 720 through the first wedge member 710 to move away from the underside of the second end 144 of the pressure plate 140.

In some embodiments, as illustrated in FIG. 7, the base 110 defines a first channel 116 extending in the axis direction of the output shaft 162 of the second motor 160, and a second channel 118 communicated with the first channel 116 and open to the second end 144 of the pressure plate 140. The first wedge member 710 is received in the first channel 116 and movable in the first channel 116, and the second wedge member 720 is received in the second channel 118 and movable in the second channel 118.

In some embodiments, as illustrated in FIG. 7, the first wedge member 710 has a first inclined surface facing the second wedge member 720, the second wedge member 720 has a second inclined surface facing the first wedge member 710, and the first wedge member 710 engages with the second wedge member 720 through the first inclined surface and the second inclined surface opposite each other. Thus, the movement of the first wedge member 710 along the first channel 116 can be converted into the movement of the second wedge member 720 along the second channel 118.

In some embodiments, as illustrated in FIG. 7, the output shaft 162 of the second motor 160 is configured as a lead screw, and the first wedge member 710 is configured as a nut cooperating with the lead screw. Thus, the rotation of the output shaft 162 of the second motor 160 can be converted into movement of the first wedge member 710 along the first channel 116.

In some embodiments, as illustrated in FIG. 8, the blade holder 100 according to the present disclosure includes a controller 170 electrically connected to the first motor 150 and the second motor 160, and the controller 170 controls the first motor 150 to drive the slide rail 120 to slide in the slide groove 114 and controls the second motor 160 to drive the pressure plate 140 to operatively press the blade 900 on the base 110. Thus, the sliding and clamping of the blade 900 can be motorized and automated.

In some embodiments, as illustrated in FIG. 8, the blade holder 100 according to the present disclosure includes an encoder 180 mounted to the first motor 150, electrically connected to the controller 170 and generating a signal corresponding to a position of the slide rail 120 relative to the base 110.

It could be understood that, the encoder 180 can generate a signal according to a rotation angle of the first motor 150, the rotation angle of the first motor 150 can determine the position of the slide rail 120 relative to the base 110, and thus the signal can correspond to the position of the slide rail 120 relative to the base 110.

Moreover, the encoder 180 is electrically connected to the controller 170, and the signal generated by the encoder 180 can be sent to the controller 170. The controller 170 can determine the position of the slide rail 120 relative to the base 110 according to the received signal, and when the blade 900 is slid to a predetermined position, the controller 170 can deactivate the first motor 150 to stop sliding of the blade 900, and activate the second motor 160 to drive the pressure plate 140 to press the blade 900 on the base 110 tightly.

In some embodiments, as illustrated in FIG. 8, the second motor 160 has a current feedback function. That is, the second motor 160 can send a current feedback signal to the controller 170. Since the current is proportional to a torque of the second motor 160, the controller 170 can control the torque of the second motor 160 according to the current feedback signal transmitted by the second motor 160.

In some embodiments, as illustrated in FIG. 8, the blade holder 100 according to the present disclosure includes a control key 192 electrically to the controller 170 and configured to generate an operation signal in response to an operation of a user, and an indicator 194 electrically connected to the controller 170 and configured to show a status of the blade holder 100 to the user. That is the control key 192 and the indicator 194 can constitutes a user interface 190 between the user and the blade holder 100.

It could be understood that, the user can achieve various operations by pressing the control key 192, for example moving the blade 900 to the left, moving the blade 900 to the right, unloading the blade 900, etc.; the indicator 194 is used to indicate the status of the blade holder 100, such as a clamped status, a moving status, etc. That is to say, a plurality of control keys 192 and a plurality of indicators can be provided to interact with the user.

In some embodiments, as illustrated in FIG. 1, the blade holder 100 further includes a box 196 fixedly mounted to the blade base 110. The first motor 150, the second motor 160, the controller 170, and the encoder 180 can be accommodated in the box 196, and the control key 192 and the indicator can be disposed at a surface of the box 196.

A blade moving system 1000 according to embodiments of the present disclosure will be described in detail below with reference to FIGS. 1 to 8.

As illustrated in FIG. 1, the blade moving system 1000 according to embodiments of the present disclosure includes a blade holder 100 according to any one of the above-described embodiments and a first container 200. The first container 200 is detachably mounted to a first side of the blade holder 100 along an extending direction of the slide groove 114 and defines an accommodating groove 210 configured to accommodate a blade 900. The accommodating groove 210 of the first container 200 is aligned with the slide groove 114 of the base 110. Thus, the blade 900 can be slid from the blade groove 112 to the accommodating groove 210 or from the accommodating groove 210 to the blade groove 112 smoothly.

It could be understood that, the blade 900 accommodated in the accommodating groove 210 of the first container 200 can serve as an replacement blade 900′ configured to replace the blade 900 accommodated in the blade groove 112 of the base 110. That is, motorized replacement of blades can be achieved, thereby greatly reducing the operational stress, increasing operational efficiency, and reducing the risk of cutting injury for the user.

In some embodiments, as illustrated in FIG. 1, a plurality of replacement blades 900′ can be provided and stacked in the accommodating groove 210 of the first container 200. Thus, multiple replacements of the blade can be achieved automatically, thereby further reducing the operational stress, increasing operational efficiency, and reducing the risk of cutting injury for the user.

It could be understood that, the first container 200 is detachably mounted to the first side of the blade holder 100, such that the first container 200 can be replaced by another first container 200 when the replacement blades 900′ of the first container 200 is used up, thereby reducing the operational stress, increasing operational efficiency, and reducing the risk of cutting injury for the user.

In some embodiments, as illustrated in FIG. 3, the protrusion 134 of each rod 132 has a cylindrical shape. Thus, the protrusion 134 can easily engage in the recess 910′ of the replacement blade 900′.

In some embodiments, as illustrated in FIG. 4, the protrusion 134 of each rod 132 has a chamfer at a side of the protrusion 134 towards the first container 200 in the length direction of the slide rail 120. Thus, the protrusion 134 at the second end of the rod 132 can easily slide onto a surface of the replacement blade 900′ in order to engage in the recess 910′ at the opposite end of the replacement blade 900′ when the engagement assembly 130 is moved from the blade groove 112 of the blade base 110 to the accommodating groove 210 of the first container 200, and hence manual operation is avoided, thereby reducing the operational stress, increasing operational efficiency, and reducing the risk of cutting injury for the user.

In some alternative embodiments, as illustrated in FIG. 5, the protrusion 134 of each rod 132 has a spherical surface. In some example, the protrusion 134 of each rod 132 has a hemispherical shape. Thus, the protrusion 134 at the second end of the rod 132 can easily slide onto a surface of the replacement blade 900′ in order to engage in the recess 910′ at the opposite end of the replacement blade 900′ when the engagement assembly 130 is moved from the blade groove 112 of the blade base 110 to the accommodating groove 210 of the first container 200, and hence manual operation is avoided, thereby reducing the operational stress, increasing operational efficiency, and reducing the risk of cutting injury for the user.

It should be noted that, the protrusion 134 may also have other structures, which is not specifically limited by the present disclosure.

In some embodiment, the first container 200 is provided with a stop member configured to limit a position of the replacement blade 900′ in the length direction of the slide rail 120 so as to prevent movement of the replacement blade 900′ in a direction away from the base 110 of the blade holder 100 in a length direction of the slide rail 120.

It could be understood that, when the engagement assembly 130 is moved from the blade groove 112 of the blade base 110 to the accommodating groove 210 of the first container 200, the stop member has a limiting effect and assists the protrusion 134 in sliding onto the surface of the replacement blade 900′ in order to engage in the recess 910′ at the opposite end of the replacement blade 900′; and after the protrusion 134 engages in the recess 910′ at the opposite end of the replacement blade 900′ and when the engagement assembly 130 is moved from the accommodating groove 210 of the first container 200 to the blade groove 112 of the blade base 110, the stop member does not have a limiting effect, and the replacement blade 900′ can be easily pushed by the protrusion 134. Hence, manual operation is avoided, thereby reducing the operational stress, increasing operational efficiency, and reducing the risk of cutting injury for the user.

In some embodiments, as illustrated in FIG. 1, the blade moving system 1000 further includes a second container 300. The second container 300 is detachably mounted to a second side of the blade holder 100 opposite the first side of the blade holder 100 along the extending direction of the slide groove 114. The second container 300 defines an upper opening 310 and is configured to receive the blade 900 through the upper opening 310.

Thus, when the blade 900 is completely slid out of the slide groove 114 and falls down under the action of the gravity, the blade 900 can conveniently collected in the second container 300, thereby avoiding manual collection of the blade 900 and reducing risk of cutting injury for the user.

It could be understood that, the second container 300 is detachably mounted to the second side of the blade holder 100, such that the second container 200 can be replaced by another second container 200 when the second container 200 is full of the used blades 900, thereby reducing the operational stress, increasing operational efficiency, and reducing the risk of cutting injury for the user.

The blade moving system 1000 according to a specific embodiment of the present disclosure will be described below with reference to FIGS. 1 to 8.

As illustrated in FIG. 1, the blade moving system 1000 according to embodiments of the present disclosure includes a blade holder 100, a first container 200, and a second container 300. The blade holder 100 includes a base 110, a slide rail 120, an engagement assembly 130 and a pressure plate 140.

As illustrated in FIG. 2, the base 110 defines a blade groove 112 and a slide groove 114. The blade groove 112 is configured to accommodating a blade 900, and the slide rail 120 is slidably accommodated in the slide groove 114. The engagement assembly 130 is mounted to the slide rail 120 and configured to engage the blade 900 such that the blade 900 is slidable along the blade groove 112 with sliding of the slide rail 120 in the slide groove 114. The pressure plate 140 movably mounted to the base 110 and configured to operatively press the blade 900 on the base 110.

Specifically, as illustrated in FIG. 1, two engagement assemblies 130 are provided and spaced apart from each other along an extending direction of the slide rail 120. Each engagement assembly 130 includes a rod 132 and a biasing part. The rod 132 has a first end pivotally mounted to the slide rail 120 and a second end provided with a protrusion 134 configured to engage in a recess 910 defined in the blade 900, and the biasing part is configured to bias the second end of the rod 132 towards the blade 900, such that the protrusion 134 of the second end of the rod 132 engage in the recess 910 defined in the blade 900, and the blade 900 can be clamped between the rod 132 and the blade groove 112 and stably slid along the blade groove 112.

As illustrated in FIGS. 1 and 8, the blade holder 100 further includes a first motor 150, a second motor 160, a controller 170, an encoder 180, and a user interface 190.

The first motor 150 is secured to the base 110 and connected to the slide rail 120 so as to drive the slide rail 120 to slide in the slide groove 114. The second motor 160 is secured to the base 110 and connected to the pressure plate 140 so as to drive the pressure plate 140 to press the blade 900 on the base 110.

The controller 170 is electrically connected to the first motor 150 and the second motor 160, and the controller 170 controls the first motor 150 to drive the slide rail 120 to slide in the slide groove 114 and controls the second motor 160 to drive the pressure plate 140 to press the blade 900 on the base 110.

The encoder 180 is mounted to the first motor 150, electrically connected to the controller 170 and generates a signal corresponding to a position of the slide rail 120 relative to the base 110. The controller 170 can determine the position of the slide rail 120 relative to the base 110 according to the signal transmitted by the encoder 180.

The user interface 190 includes a control key 192 electrically connected to the controller 170 and configured to generate an operation signal in response to an operation of a user, and an indicator 194 electrically connected to the controller 170 and configured to show a status of the blade holder 100 to the user.

It could be understood that, the blade 900 is located in a normal position where the blade 900 is used to cut and trim the specimen. After several times of cutting and trimming of the specimen, the blade 900 is not sharp anymore, and the blade 900 needs to be replaced by a replacement blade 900′.

Furthermore, a method for replacing the blade with the above-described blade moving system 1000 may include followings steps.

The controller 170 controls the second motor 160 to rotate so as to release the blade 900 from the base 110, and activates the first motor 150 to rotate in a first direction, so as to drive the slide rail 120 to slide away from the first container 200 along the slide groove 114.

The controller 170 deactivates the first motor 150 when receiving a signal from the encoder 180 corresponding to a first limit position where the blade 900 is completely slid out of the slide groove 114 and falls down into the second container 300 through the upper opening 310 under the action of the gravity.

The controller 170 activates the first motor 150 to rotate in a second direction opposite the first direction, so as to drive the slide rail 120 to slide towards the first container 200 along the slide groove 114.

The controller 170 deactivates the first motor 150 when receiving a signal from encoder 180 corresponding to a second limit position where the rod 132 of the engagement assembly 130 can engage in the replacement blade 900′ accommodated in the accommodating groove 210 of the first container 200.

The controller 170 activates the first motor 150 to rotate in the first direction, so as to drive the slide rail 120 to slide away from the first container 200 along the slide groove 114.

The controller 170 deactivates the first motor 150 when receiving a signal from encoder 180 corresponding to the normal position, such that the replacement blade 900′ is located in the slide groove 114 of the blade holder 100.

The controller 170 controls the second motor 160 rotate inversely to drive the pressure plate 140 to press the replacement blade 900′ on the base 110 tightly, such that the replacement blade 900′ can be used to cut and trim the specimen.

Thus, the replacement of the blade 900 and the replacement blade 900′ can be realized automatically with less manual operation, thereby greatly reducing the operational stress, increasing operational efficiency, and reducing the risk of cutting injury for the user.

Additionally, another method for replacing the blade with the above-described blade moving system 1000 may include followings steps.

The controller 170 activates the first motor 150 to rotate in the second direction, so as to drive the slide rail 120 to slide towards the first container 200 along the slide groove 114.

The controller 170 deactivates the first motor 150 when receiving a signal from the encoder 180 corresponding to the second limit position where the rod 132 of the engagement assembly 130 can engage in the replacement blade 900′ accommodated in the accommodating groove 210 of the first container 200 and controls the second motor 160 to rotate so as to release the blade 900 from the base 110.

The controller 170 activates the first motor 150 to rotate in the first direction opposite the second direction, so as to drive the slide rail 120 to slide away from the first container 200 along the slide groove 114.

The controller 170 deactivates the first motor 150 when receiving a signal from encoder 180 corresponding to the normal position, such that the replacement blade 900′ is located in the slide groove 114 of the blade holder 100. It could be understood that, the blade 900 is pushed out of the slide groove 114 by the replacement blade 900′, and falls down into the second container 300 through the upper opening 310 under the action of gravity.

The controller 170 controls the second motor 160 to rotate inversely to drive the pressure plate 140 to press the replacement blade 900′ on the base 110 tightly, such that the replacement blade 900′ can be used to cut and trim the specimen.

Thus, the replacement of the blade 900 and the replacement blade 900′ can be realized automatically with less manual operation, thereby greatly reducing the operational stress, increasing operational efficiency, and reducing the risk of cutting injury for the user.

It should note that, the above steps can be controlled by one control key or can be controlled by several control keys.

A microtome 2000 according to embodiments of the present disclosure will be described in detail below with reference to FIGS. 1 to 8.

The microtome 2000 according to embodiments of the present disclosure includes a blade 900, a blade moving system 1000 according to any one of the above embodiments and a specimen holder 800 disposed near the blade holder 100 and movable vertically relative to the blade holder 100 such that a specimen block 810 held by the specimen holder 800 is able to pass through the blade 900 clamped by the blade holder 100.

For the microtome 2000 according to embodiments of the present disclosure, by employing the above blade moving system 1000, when the blade 900 needs to be replaced, the user can just press the control key 192, such that the blade 900 accommodated in the slide groove 114 can be replaced by another blade 900 accommodated in the accommodating groove 210 of the first container 200, and can be collected in the second container 300 automatically, thereby greatly reducing the operational stress, increasing operational efficiency, and reducing the risk of cutting injury for the user.

In some embodiments, a width of the specimen block 810 is denoted by W1, a width of the blade 900 in the extending direction of the guide rail 120 is denoted by W2, and W1≤W2≤2*W1. That is, the width W2 of the blade 900 in the extending direction of the guide rail 120 is greater than or equal to the width W1 of the specimen block 810 and is less than or equal to two times of the width W1 of the specimen block 810. Thus, the operating space for the user can be improved. In an example, the width W1 of the specimen block 810 is usually 28 mm, and thus the width W2 of the blade 900 in the extending direction of the guide rail 120 is greater than or equal to 28 mm and is less than or equal to 56 mm.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A blade holder (100), comprising:
a base (110) defining a blade groove (112) and a slide groove (114), the blade groove (112) being configured to accommodating a blade (900);
a slide rail (120) slidably accommodated in the slide groove (114); and
an engagement assembly (130) mounted to the slide rail (120) and configured to engage the blade (900) such that the blade (900) is slidable along the blade groove (112) with sliding of the slide rail (120) in the slide groove (114).

2. The blade holder (100) according to claim 1, wherein the engagement assembly (130) comprises a rod (132) and a biasing part, the rod (132) has a first end pivotally mounted to the slide rail (120) and a second end provided with a protrusion (134) configured to engage in a recess (910) defined in the blade (900), and the biasing part is configured to bias the second end of the rod (132) towards the blade (900).

3. The blade holder (100) according to claim 2, wherein the engagement assembly (130) further comprises a limiting part (136) configured to prevent the protrusion (134) at the second end of the rod (132) from moving beyond a wall face of the blade groove (112) facing the protrusion (134) at the second end of the rod (132).

4. The blade holder (100) according to claim 1, further comprising:
a pressure plate (140) movably mounted to the base (110) and configured to operatively press the blade (900) on the base (110).

5. The blade holder (100) according to claim 4, further comprising:
a first motor (150) secured to the base (110) and connected to the slide rail (120) so as to drive the slide rail (120) to slide in the slide groove (114); and
a second motor (160) secured to the base (110) and connected to the pressure plate (140) so as to drive the pressure plate (140) to press the blade (900) on the base (110).

6. The blade holder (100) according to claim 5, wherein the first motor (150) is provided with a pinion (152) at an output end thereof, the slide rail (120) is provided with a rack (122), and the pinion (152) is engaged with the rack (122) to achieve power transmission from the first motor (150) to the slide rail (120).

7. The blade holder (100) according to claim 6, wherein the slide rail (120) is provided with a rib (124) at a side of the slide rail (120), and a side wall of the slide groove (114) defines a slot matching the rib (124) of the slide rail (120).

8. The blade holder (100) according to claim 7, wherein the rack (122) is provided at a lower portion of the slide rail (120) and spaced apart from a bottom wall of the slide groove (114).

9. The blade holder (100) according to claim 5, further comprising:
a controller (170) electrically connected to the first motor (150) and the second motor (160), and the controller (170) controlling the first motor (150) to drive the slide rail (120) to slide in the slide groove (114) and controlling the second motor (160) to drive the pressure plate (140) to press the blade (900) on the base (110).

10. The blade holder (100) according to claim 9, further comprising:
an encoder (180) mounted to the first motor (150), electrically connected to the controller (170) and detecting a position of the slide rail (120) relative to the base (110).

11. The blade holder (100) according to claim 9, further comprising:
a control key (192) electrically to the controller (170) and configured to generate an operation signal in response to an operation of a user, and
an indicator (194) electrically connected to the controller (170) and configured to show a status of the blade holder (100) to the user.

12. A blade moving system (1000), comprising:
a blade holder (100) comprising:
a base (110) defining a blade groove (112) and a slide groove (114), the blade groove (112) being configured to accommodating a blade (900);
a slide rail (120) slidably accommodated in the slide groove (114); and
an engagement assembly (130) mounted to the slide rail (120) and configured to engage the blade (900) such that the blade (900) is slidable along the blade groove (112) with sliding of the slide rail (120) in the slide groove (114); and
a first container (200) detachably mounted to a first side of the blade holder (100) along an extending direction of the slide groove (114) and defining an accommodating groove (210) configured to accommodate the blade (900),
wherein the accommodating groove (210) of the first container (200) is aligned with the slide groove (114) of the base (110).

13. The blade moving system (1000) according to claim 12, further comprising:
a second container (300) detachably mounted to a second side of the blade holder (100) opposite the first side along the extending direction of the slide groove (114),
wherein the second container (300) defines an upper opening (310) and is configured to receive the blade (900) through the upper opening (310).

14. A microtome (2000), comprising:
a blade moving system (1000) comprising:
a blade holder (100) comprising:
a base (110) defining a blade groove (112) and a slide groove (114), the blade groove (112) being configured to accommodating a blade (900);
a slide rail (120) slidably accommodated in the slide groove (114); and
an engagement assembly (130) mounted to the slide rail (120) and configured to engage the blade (900) such that the blade (900) is slidable along the blade groove (112) with sliding of the slide rail (120) in the slide groove (114); and
a first container (200) detachably mounted to a first side of the blade holder (100) along an extending direction of the slide groove (114) and defining an accommodating groove (210) configured to accommodate the blade (900), wherein the accommodating groove (210) of the first container (200) is aligned with the slide groove (114) of the base (110); and
a specimen holder (800) disposed near the blade holder (100) and movable vertically relative to the blade holder (100) such that a specimen block (810) held by the specimen holder (800) is able to pass through the blade (900) clamped by the blade holder (100).
